(19) United States
(12) Patent Application Publication
(10) Pub. No.: US 2020/0209893 A1
(43) Pub. Date: Jul. 2, 2020

(54) UAV OBSTACLE AVOIDANCE SYSTEM AND CONTROL METHOD THEREOF

(71) Applicant: Coretronic Corporation, Hsin-Chu (TW)

(72) Inventors: Kuo-Chang Lee, Hsin-Chu (TW); Chih-Neng Tseng, Hsin-Chu (TW); Cheng-Shen Lee, Hsin-Chu (TW)

(73) Assignee: Coretronic Corporation, Hsin-Chu (TW)

(21) Appl. No.: 16/726,950

(22) Filed: Dec. 26, 2019

(30) Foreign Application Priority Data
Dec. 28, 2018 (CN) 201811620756.0

(51) Int. Cl. G05D 1/10; H04N 5/33; B64D 47/08; B64C 39/02

(52) U.S. Cl. CPC G05D 1/106; H04N 5/332; B64C 2201/141; B64C 39/024; B64C 2201/027; B64D 47/08

(57) ABSTRACT

A UAV obstacle avoidance system and a control method thereof are provided. The UAV obstacle avoidance system comprises a cover, at least two obstacle avoidance lens modules and an infrared light source. The infrared light source is located between the at least two obstacle avoidance lens modules. Each obstacle avoidance lens module comprises a sensing unit and an infrared shutter. The sensing unit comprises a filter layer and a sensing element. The filter layer is located between the cover and the sensing element, and the filter layer has at least one filter region, wherein one of the filter regions is an infrared filter region. The infrared shutter is located between the cover and the sensing unit and configured to switch an infrared cut-off filter to a turn-on state or a turn-off state. The UAV obstacle avoidance system and the control method thereof can be used for day and night environments.

### CROSS-REFERENCE TO RELATED APPLICATION

This application claims the priority benefit of China application serial no. 201811620756.0, filed on Dec. 28, 2018. The entirety of the above-mentioned patent application is hereby incorporated by reference herein and made a part of this specification.

### BACKGROUND OF THE INVENTION

### 1. Field of the Invention

The present invention relates to an obstacle avoidance system and a control method thereof, in particular, to a UAV obstacle avoidance system and a control method thereof.

### 2. Description of Related Art

In recent years, unmanned aerial vehicle (UAV) products have gradually evolved from consumer products to industrial application products. At the same time, in order to improve the efficiency of industrial application, various manufacturers have tried to introduce full-autonomous operation functions into UAV systems. In a full-autonomous operation mode, because of no manual remote control assistance, the UAV needs to judge an object in front and avoids it in time to maintain the normal and stable operation. Thus, obstacle avoidance is the most important function for the UAVs of industrial application products.

The obstacle avoidance technology currently applied to the UAVs is a dual-lens obstacle avoidance technology. That is, a dual-lens module is used to simulate human eyes to capture images from different angles, and the object distance is estimated from the image difference of two lenses. However, the current dual-lens obstacle avoidance technology mostly uses the conventional image capturing lenses of three primary colors. The image capturing lens is provided with an infrared cut-off filter on a sensing element to filter the infrared so as to avoid affecting the visible light image effect. However, as a result, the brightness of images is too low at night, which affects the image capturing effect. In this way, the obstacle avoidance function of the UAV easily fails, thus affecting the autonomous operation of the UAV at night.

On the other hand, the existing UAV obstacle avoidance technologies can be divided into four classes and can be divided into the aforementioned dual-lens obstacle avoidance technology, a structured light obstacle avoidance technology, and ultrasonic and light wave time of flight (TOF) obstacle avoidance technologies based on the technical principle. However, the aforementioned other technologies still have application limitations. For example, the structured light obstacle avoidance technology and the light wave TOF obstacle avoidance technology used at night are easily disturbed by strong light during the day, thus affecting the sensing effect. Although the ultrasonic TOF obstacle avoidance technology can be used during the day and at night, the sound wave sensing is susceptible to the environmental noise and the sound absorption of the object, and the sound wave transmission speed is low, affecting the moving speed of the UAV, so that this technology is not suitable for the UAV system.

Therefore, a UAV obstacle avoidance system and technology that can be used in day and night environments is one of the important topics in the field of research and development of UAV systems at present.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention were acknowledged by a person of ordinary skill in the art.

### SUMMARY OF THE INVENTION

The present invention provides a UAV obstacle avoidance system and a control method thereof, which can be used for day and night environments.

Other objectives and advantages of the present invention can be understood from the technical features disclosed in the present invention.

In order to achieve one, some, or all of the aforementioned objectives or other objectives, an embodiment of the present invention provides a UAV obstacle avoidance system. The UAV obstacle avoidance system includes a cover, at least two obstacle avoidance lens modules and an infrared light source. The cover is configured to allow infrared and visible light to pass. Each of the obstacle avoidance lens modules includes a sensing unit and an infrared shutter. The sensing unit includes a filter layer and a sensing element. The filter layer is located between the cover and the sensing element, and the filter layer has at least one filter region, wherein one of the filter regions is an infrared filter region. The infrared shutter is located between the cover and the sensing unit and configured to switch an infrared cut-off filter to a turn-on state or a turn-off state. The infrared light source is located between the at least two obstacle avoidance lens modules.

In order to achieve one or part or all of the above or other objectives, an embodiment of the present invention provides a control method for a UAV obstacle avoidance system. The UAV obstacle avoidance system includes an infrared light source and at least two obstacle avoidance lens modules, each of the obstacle avoidance lens modules has a sensing unit and an infrared shutter, the sensing unit includes an infrared filter region, and the infrared shutter is configured to switch an infrared cut-off filter to a turn-on state or a turn-off state. The control method for the UAV obstacle avoidance system includes the following steps: estimating whether the environment light brightness is lower than a preset threshold; and when the environment light brightness is lower than the preset threshold, turning on the infrared light source, and switching, by the infrared shutter, the infrared cut-off filter to a turn-off state, so as to allow the infrared light can enter the infrared filter region of the sensing unit.

Based on the above, the embodiments of the present invention have at least one of the following advantages or effects. In the embodiments of the present invention, the UAV obstacle avoidance system can simultaneously acquire visible light images and infrared images by means of the infrared filter region of the filter layer of the sensing unit. In the day environment, the UAV obstacle avoidance system can acquire visible light images as the basis for object identification; and in the night environment, the UAV obstacle avoidance system can also acquire infrared images as the basis for object identification, so the system can be used in the day and night environments to realize full-autonomous operation. Moreover, since the UAV obstacle avoidance system can simultaneously acquire visible light images and infrared images by just a single sensing unit, there is no need of multiple types of sensors, so that the size and weight of the system can be reduced. In addition, since the UAV obstacle avoidance system can capture infrared images, the number of light sources for reinforcing light can be reduced, and the cost, size and weight of the system are reduced. In addition, the UAV obstacle avoidance system and the control method thereof can determine that the environment is a day environment or a night environment based on the environment light intensity, and select an operating mode applicable to the environment.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a front view of a UAV obstacle avoidance system according to an embodiment of the present invention.

FIG. 2A is a structure diagram of a cover and obstacle avoidance lens modules of FIG. 1.

FIG. 2B is an internal structure diagram of an obstacle avoidance lens module of FIG. 1.

FIG. 2C is an internal structure diagram of a sensing unit of FIG. 2B.

FIG. 2D is a top view of a filter layer of FIG. 2C.

FIG. 3A is a block diagram of a UAV obstacle avoidance system according to an embodiment of the present invention.

FIG. 3B is a flow diagram of a control method for a UAV obstacle avoidance system according to an embodiment of the present invention.

FIG. 4A is an internal structure diagram of another sensing unit according to an embodiment of the present invention.

FIG. 4B is a top view of a filter layer of FIG. 4A.

FIG. 5A is an internal structure diagram of another sensing unit according to an embodiment of the present invention.

FIG. 5B is a top view of a filter layer of FIG. 5A.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

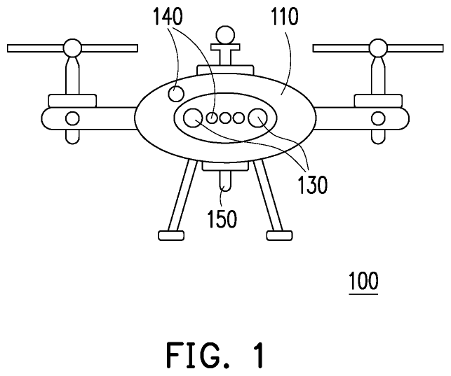

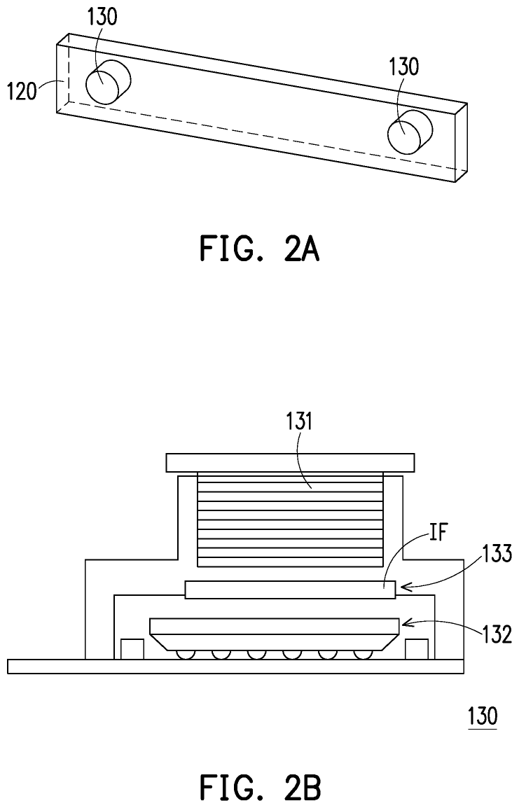

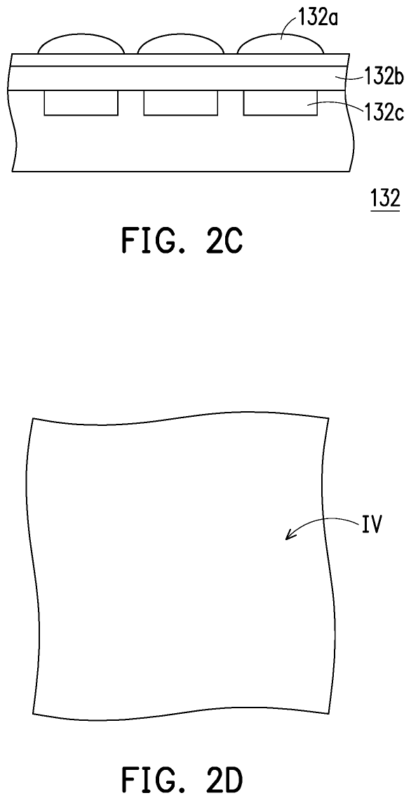

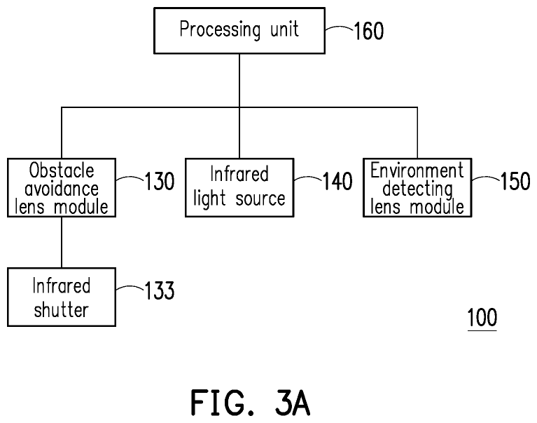

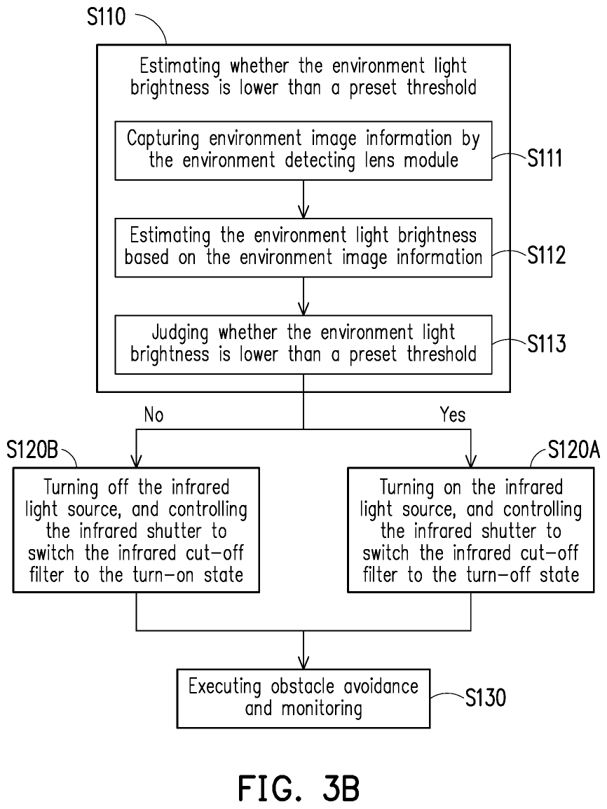

FIG. 1 is a front view of a UAV obstacle avoidance system 100 according to an embodiment of the present invention. FIG. 2A is a structure diagram of a cover 120 and obstacle avoidance lens modules 130 of FIG. 1. FIG. 2B is an internal structure diagram of an obstacle avoidance lens module 130 of FIG. 1. FIG. 2C is an internal structure diagram of a sensing unit 132 of FIG. 2B. FIG. 2D is a top view of a filter layer 132b of FIG. 2C. FIG. 3A is a block diagram of a UAV obstacle avoidance system according to an embodiment of the present invention. A UAV includes an UAV obstacle avoidance system 100, and the UAV avoidance system 100 is configured to allow the UAV to achieve an obstacle avoidance function during the day and at night. The UAV obstacle avoidance system 100 includes a housing 110, a cover 120, at least two obstacle avoidance lens modules 130 and an infrared light source 140. Specifically, as shown in FIG. 1 and FIG. 2A, in the present embodiment, the cover 120 and the obstacle avoidance lens modules 130 are received in the housing 110, and the cover 120 covers the obstacle avoidance lens modules 130. In addition, as shown in FIG. 1, in the present embodiment, the infrared light source 140 may be located between the at least two obstacle avoidance lens modules 130 or on the housing 110, and is configured to provide infrared illumination beams when the UAV obstacle avoidance system 100 is in a night environment, to supplement the light required to capture images when the light is insufficient.

More specifically, as shown in FIG. 2B and FIG. 2D, in the present embodiment, each of the obstacle avoidance lens modules 130 includes a lens group 131, a sensing unit 132 and an infrared shutter 133. The infrared shutter 133 is located between the cover 120 and the sensing unit 132, and is configured to switch an infrared cut-off filter IF to a turn-on state or a turn-off state. The lens group 131 is located between the cover 120 and the sensing unit 132 and configured to image light onto the sensing unit 132. As shown in FIG. 2C, in the present embodiment, the sensing unit 132 includes a microlens array 132a, a filter layer 132b and a sensing element 132c. Specifically, in the present embodiment, the microlens array 132a is located on the filter layer 132b, and is configured to concentrate and image the light from the lens group 131 on the sensing element 132c. For example, in the present embodiment, the sensing element 132c may be a global shutter or a rolling shutter.

More specifically, as shown in FIG. 2C and FIG. 2D, in the present embodiment, the filter layer 132b is located between the cover 120 and the sensing element 132c, and the filter layer 132b is configured to allow infrared and visible light to pass and has at least a filter region, wherein the filter region is an infrared filter region IV. For example, the filter layer 132b is a bandpass filter that allows infrared and visible light to pass.

In the present embodiment, the infrared filter region IV contains a filter material that allows infrared light to pass. More specifically, in the present embodiment, the infrared filter region IV is configured to allow at least the infrared light to pass, and the light wave band penetrating the filter material ranges from 0.75 to 10 micrometers. Further, in the present embodiment, infrared and visible light can be allowed to pass through the cover 120. In another embodiment, at least the light in the light wave band range of 0.75 to 10 micrometers can be allowed to pass the cover 120. Since both the cover 120 and the filter layer 132b allow the infrared and visible light to pass, the infrared and visible light coming from the outside can pass through the cover 120, the lens group 131 and the filter layer 132b, and are imaged on the sensing element 132c of the sensing unit 132. In other words, in the present embodiment, the obstacle avoidance lens modules 130 can be configured to capture visible light images and infrared images.

Also, for example, in an embodiment, the penetration rate of the infrared band penetrating the cover 120 is greater than that of the visible light band penetrating the cover 120, and in the equivalent penetration spectra of the lens group 131, the penetration rate of the infrared band is also greater than that of the visible light band. Thus, the obstacle avoidance lens modules 130 can capture infrared images with higher definition when the UAV obstacle avoidance system 100 is in the night environment. Further, in an embodiment, the infrared filter region IV contains a color conversion material. For example, in an embodiment, the color conversion material may be a quantum dot material or a wavelength conversion material for converting visible light to infrared light. Thus, it is also helpful to capture infrared images with higher definition when the UAV obstacle avoidance system 100 is in the night environment.

In this way, the UAV obstacle avoidance system 100 can simultaneously acquire visible light images and infrared images by means of the infrared filter region IV of the filter layer 132b of the sensing unit 132. In the day environment, the UAV obstacle avoidance system 100 can acquire visible light images as the basis for object identification; and in the night environment, the UAV obstacle avoidance system 100 can also acquire infrared images as the basis for object identification, so the system can be used in the day and night environments to realize full-autonomous operation. Moreover, since the UAV obstacle avoidance system 100 can simultaneously acquire visible light images and infrared images by just a single sensing unit 132, there is no need of multiple types of sensors, so that the size and weight of the system can be reduced. In addition, since the UAV obstacle avoidance system 100 can capture infrared images, the number of light sources for reinforcing light can be reduced, and the cost, size and weight of the system are reduced.

As shown in FIG. 1 and FIG. 3A, in the present embodiment, the UAV obstacle avoidance system 100 further includes an environment detecting lens module 150 and a processing unit 160. The environment detecting lens module 150 is configured to capture environment image information. The processing unit 160 is electrically connected to the environment detecting lens module 150, each of the obstacle avoidance lens modules 130 and the infrared light source 140. The processing unit 160 estimates the environment light brightness based on the environment image information. When the environment light brightness is lower than a preset threshold, the processing unit 160 controls the infrared light source 140 to be turned on, and controls the infrared shutter 133 to switch the infrared cut-off filter IF to the turn-off state. For example, in the present embodiment, the infrared shutter 133 is of a mechanical structure for causing the infrared cut-off filter IF to enter or leave the range of the sensing element 132c irradiated by external light. Thus, the UAV obstacle avoidance system 100 can determine that the environment is a day environment or a night environment based on the environment light intensity, and select an operating mode applicable to the environment. In an embodiment, when the environment light brightness is lower than a preset threshold, the processing unit 160 may only turn on the infrared light source 140 to reinforce the infrared light. In another embodiment, when the environment light brightness is lower than a preset threshold, the processing unit 160 may only close the infrared cut-off filter IF to increase the sensed light.

Further description is given below in conjunction with FIG. 3B.

FIG. 3B is a flow diagram of a control method for a UAV obstacle avoidance system according to an embodiment of the present invention. For example, the UAV obstacle avoidance system 100 shown in FIG. 1 and FIG. 3A can be used to execute the control method for the UAV obstacle avoidance system 100 in FIG. 3B, so that the UAV obstacle avoidance system 100 selects an operating mode applicable to the environment, but the present invention is not limited thereto.

Specifically, as shown in FIG. 3A and FIG. 3B, in the present embodiment, the processing unit 160 and the environment detecting lens module 150 of the UAV obstacle avoidance system 100 can be used to execute step S110, i.e., estimating whether the environment light brightness is lower than a preset threshold. In detail, as shown in FIG. 3B, in the present embodiment, step S110 of estimating whether the environment light brightness is lower than a preset threshold includes steps S111, S112 and S113 below. First, step S111 of capturing environment image information by the environment detecting lens module 150 is executed. Next, step S112 of estimating the environment light brightness by the processing unit 160 based on the environment image information is executed. And, step S113 of judging whether the environment light brightness is lower than a preset threshold by the processing unit 160 is executed.

Then, as shown in FIG. 3A and FIG. 3B, in the present embodiment, when the processing unit 160 judges that the environment light brightness is lower than the preset threshold, the processing unit 160 executes step S120A, i.e., turning on the infrared light source 140, and controlling the infrared shutter 133 to switch the infrared cut-off filter IF to the turn-off state, so that the infrared light can enter the infrared filter region IV of the sensing unit 132. In an embodiment, the processing unit 160 executes step S120A of turning on only the infrared light source 140. In another embodiment, the processing unit 160 executes step S120A of closing only the infrared cut-off filter IF.

Next, as shown in FIG. 3A and FIG. 3B, in the present embodiment, the processing unit 160 and the obstacle avoidance lens modules 130 of the UAV obstacle avoidance system 100 can be used to execute step S130, that is, executing obstacle avoidance and monitoring. For example, step S130 may be executed as follows: the obstacle avoidance lens modules 130 respectively capture image information, the image information being infrared image information; and the processing unit 160 estimates whether an obstacle is in front based on the image information, and further calculates the distance from the obstacle to the UAV obstacle avoidance system 100 in the presence of the obstacle so as to execute the obstacle avoidance function. Thus, when the external light is insufficient (e.g., in the night environment), the UAV obstacle avoidance system 100 can be used to capture infrared image information, and implement the obstacle avoidance function.

On the other hand, as shown in FIG. 3A and FIG. 3B, in the present embodiment, when the processing unit 160 judges that the environment light brightness is higher than the preset threshold, since the external light in this case is sufficient, the processing unit 160 determines to execute step S120B, i.e., turning off the infrared light source 140, and controlling the infrared shutter 133 to switch the infrared cut-off filter IF to the turn-on state. Thus, only visible light is transmitted to the sensing unit 132. Then, the processing unit 160 and the obstacle avoidance lens modules 130 execute step S130, that is, execute obstacle avoidance and monitoring. The image information acquired by the obstacle avoidance lens modules 130 in this case is visible light image information. When the external light is sufficient (e.g., in the day environment), the UAV obstacle avoidance system 100 can be used to capture visible light image information, and implement the obstacle avoidance function.

Accordingly, the UAV obstacle avoidance system 100 and the control method thereof can determine that the environment is a day environment or a night environment based on the environment light intensity, and select an operating mode applicable to the environment. In addition, the processing unit 160 can be used to execute an image processing algorithm for image processing on the environment image information acquired by the environment detecting lens module 150 or the image information acquired by the obstacle avoidance lens modules 130 to improve the image capturing quality. After receiving the environment image information of the environment detecting lens module 150, the processing unit 160 can execute an auto gain control based on the environment image information to prevent the acquired image information from being overexposed or too dark. Moreover, the processing unit 160 can perform image processing such as image noise reduction or edge enhancement on the image information acquired by the obstacle avoidance lens modules 130, thereby improving the image capturing quality.

In the present embodiment, the image information acquired by the environment detecting lens module 150 at night is black and white visible light image information. In this case, the processing unit 160 can also perform AI image coloring on the visible light image information or the infrared image information acquired by the obstacle avoidance lens modules 130 in combination with the training of an AI algorithm, to convert the same into a color image to facilitate the interpretation and identification of the image information.

In the foregoing embodiment, the filter layer 132b including one type of filter region is used as an example, but the present invention is not limited thereto. In other embodiments, the filter layer 132b may also include multiple types of filter regions. Some examples are given below as an illustration.

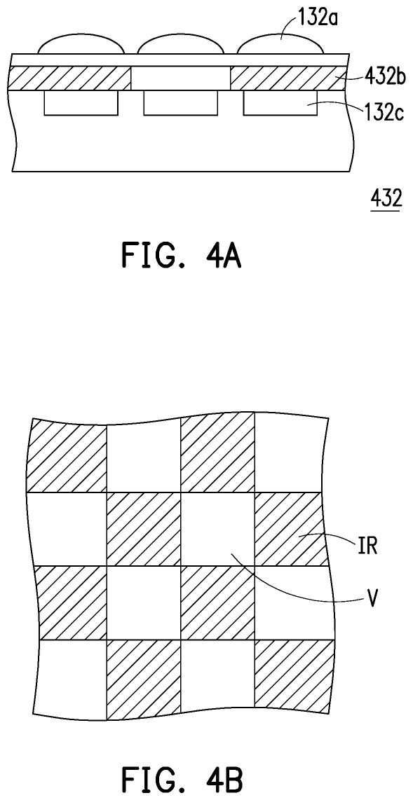

FIG. 4A is an internal structure diagram of another sensing unit according to an embodiment of the present invention. FIG. 4B is a top view of a filter layer of FIG. 4A. Referring to FIG. 4A and FIG. 4B, the filter layer 432b of the sensing unit 432 in the present embodiment is similar to the filter layer 132b of the sensing unit 132 in FIG. 2C and FIG. 2D, and the difference between the two is as follows. In the embodiment of FIG. 4A and FIG. 4B, the number of at least one filter region of the filter layer 432b is plural. More specifically, as shown in FIG. 4B, in the present embodiment, the filter regions of the filter layer 432b includes another visible light filter region V besides the infrared filter region IR, and the area of the infrared filter region IR is substantially larger than that of the visible light filter region V (not shown in the figure). More specifically, in the present embodiment, the infrared filter region IR is only configured to allow the infrared light to pass, the light wave band penetrating the filter material of the infrared filter region IR ranges from 0.75 to 3 micrometers or from 0.75 to 10 micrometers, and the light wave band penetrating the visible light filter region V ranges from 0.3 to 0.8 micrometer. Thus, the sensing unit 432 can acquire an infrared image by means of the infrared filter region IR of the filter layer 432b, and can also acquire a visible light image by means of the visible light filter region V of the filter layer 432b.

Moreover, in the present embodiment, since the sensing unit 432 and the sensing unit 132 of FIG. 2C have a similar structure, when the sensing unit 432 is used for the UAV obstacle avoidance system 100, the UAV obstacle avoidance system 100 can also simultaneously acquire visible light images and infrared images, so as to be used in day and night environments, thereby achieving full-autonomous operation. When the sensing unit 432 is used for the UAV obstacle avoidance system 100, the UAV obstacle avoidance system 100 can also be used to execute the aforementioned control method for the UAV obstacle avoidance system 100 as shown in FIG. 3B, and achieve the aforementioned functions and advantages mentioned in the UAV obstacle avoidance system 100, and the descriptions thereof are omitted herein.

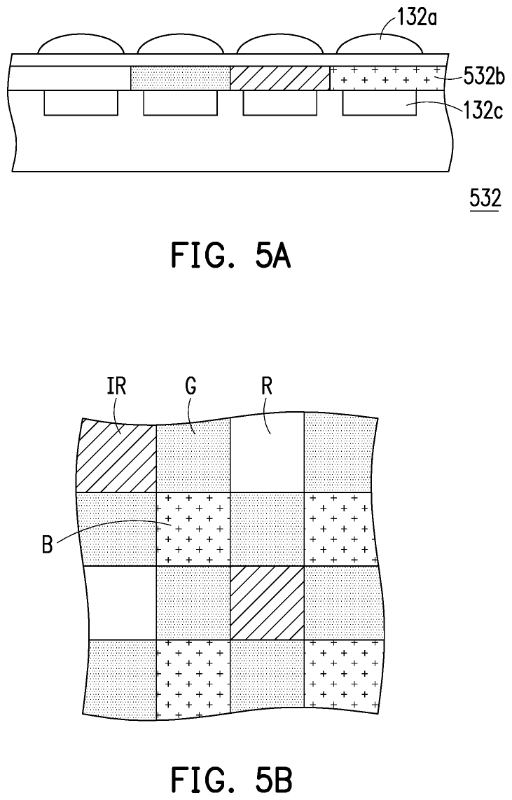

FIG. 5A is an internal structure diagram of another sensing unit according to an embodiment of the present invention. FIG. 5B is a top view of a filter layer of FIG. 5A. Referring to FIG. 5A and FIG. 5B, the filter layer 532b of the sensing unit 532 in the present embodiment is similar to the filter layer 432b of the sensing unit 432 in FIG. 4A and FIG. 4B, and the difference between the two is as follows. As shown in FIG. 5A and FIG. 5B, in the present embodiment, the filter regions of the filter layer 532b of the sensing unit 532 include a plurality of different visible light filter regions R, G and B besides the infrared filter region IR, to allow red visible light, green visible light and blue visible light to pass respectively. For example, in the present embodiment, a part of the visible light filter regions R, G and B and the other part of the visible light filter regions R, G and B respectively allow visible light of different bands to pass. In other words, in the present embodiment, the visible light filter regions R, G and B can allow the visible light of different colors to pass. For example, the visible light filter regions R, G and B may include a red light filter region R, a green light filter region G and a blue light filter region B. Thus, the sensing unit 532 can acquire a colored visible light image by means of the different visible light filter regions R, G and B of the filter layer 532b.

Moreover, in the present embodiment, since the sensing unit 532 and the sensing unit 432 have a similar structure, when the sensing unit 532 is used for the UAV obstacle avoidance system 100, the UAV obstacle avoidance system can also simultaneously acquire visible light images and infrared images, so as to be used in day and night environments, thereby achieving full-autonomous operation. When the sensing unit 532 is used for the UAV obstacle avoidance system 100, the UAV obstacle avoidance system 100 can also be used to execute the aforementioned control method for the UAV obstacle avoidance system 100 as shown in FIG. 3B, and achieve the aforementioned functions and advantages mentioned in the UAV obstacle avoidance system 100, and the descriptions thereof are omitted herein.

Based on the above, the embodiments of the present invention have at least one of the following advantages or effects. In the embodiments of the present invention, the UAV obstacle avoidance system can simultaneously acquire visible light images and infrared images by means of the infrared filter region of the filter layer of the sensing unit. In the day environment, the UAV obstacle avoidance system can acquire visible light images as the basis for object identification; and in the night environment, the UAV obstacle avoidance system can also acquire infrared images as the basis for object identification, so the system can be used in the day and night environments to realize full-autonomous operation. Moreover, since the UAV obstacle avoidance system can simultaneously acquire visible light images and infrared images by just a single sensing unit, there are no need of multiple types of sensors, so that the size and weight of the system can be reduced. In addition, since the UAV obstacle avoidance system can capture infrared images, the number of light sources for reinforcing light can be reduced, and the cost, size and weight of the system are reduced. In addition, the UAV obstacle avoidance system and the control method thereof can determine that the environment is a day environment or a night environment based on the environment light intensity, and select an operating mode applicable to the environment.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A UAV obstacle avoidance system, comprising:
a cover, configured to allow infrared and visible light to pass;
at least two obstacle avoidance lens modules, wherein each of the obstacle avoidance lens modules comprising:
a sensing unit, comprising:
a filter layer, comprising at least one filter region, wherein one of the filter regions is an infrared filter region; and
a sensing element, wherein the filter layer is located between the cover and the sensing element; and
an infrared shutter, located between the cover and the sensing unit and configured to switch an infrared cut-off filter to a turn-on state or a turn-off state; and
an infrared light source, providing infrared illumination beams.

2. The UAV obstacle avoidance system according to claim 1, wherein the infrared filter region comprises a filter material allowing infrared light to pass.

3. The UAV obstacle avoidance system according to claim 2, wherein the light wave band penetrating the filter material ranges from 0.75 to 10 micrometers.

4. The UAV obstacle avoidance system according to claim 2, wherein the sensing unit comprises a plurality of infrared filter regions, the plurality of infrared filter regions is provided to allow the infrared light to pass, and the light wave band penetrating the filter material ranges from 0.75 to 3 micrometers.

5. The UAV obstacle avoidance system according to claim 1, wherein another filter region is a visible light filter region, and the area of the infrared filter region is substantially larger than that of the visible light filter region.

6. The UAV obstacle avoidance system according to claim 1, wherein a plurality of visible light filter regions are provided, a part of the plurality of visible light filter regions and the other part of the plurality of visible light filter regions respectively allow visible light of different bands to pass, and the area of the infrared filter region is substantially larger than that of the visible light filter region.

7. The UAV obstacle avoidance system according to claim 1, wherein the infrared filter region comprises a color conversion material for converting visible light into infrared light.

8. The UAV obstacle avoidance system according to claim 1, wherein the light wave band penetrating the cover ranges at least from 0.75 to 10 micrometers.

9. The UAV obstacle avoidance system according to claim 1, wherein the penetration rate of the infrared band penetrating the cover is greater than that of the visible light band penetrating the cover.

10. The UAV obstacle avoidance system according to claim 1, wherein the obstacle avoidance lens module further comprises a lens group, the lens group being located between the cover and the sensing unit.

11. The UAV obstacle avoidance system according to claim 9, wherein in equivalent penetration spectra of the lens group, the penetration rate of the infrared band is greater than that of the visible light band.

12. The UAV obstacle avoidance system according to claim 1, wherein the sensing unit further comprises a microlens array, the microlens array being located on the filter layer.

13. The UAV obstacle avoidance system according to claim 1, wherein the sensing element comprises a global shutter or a rolling shutter.

14. The UAV obstacle avoidance system according to claim 1, further comprising:
an environment detecting lens module for capturing environment image information; and
a processing unit, electrically connected to the environment detecting lens module, each of the obstacle avoidance lens modules and the infrared light source, wherein the processing unit estimates environment light brightness based on the environment image information, and when the environment light brightness is lower than a preset threshold, the processing unit controls the infrared light source to be turned on, and controls the infrared shutter to switch an infrared cut-off filter to a turn-off state.

15. A control method for a UAV obstacle avoidance system, applied to the UAV obstacle avoidance system, wherein the UAV obstacle avoidance system comprises an infrared light source and at least two obstacle avoidance lens modules, each of the obstacle avoidance lens modules comprises a sensing unit and an infrared shutter, the sensing unit comprises an infrared filter region, the infrared shutter is configured to switch an infrared cut-off filter to a turn-on state or a turn-off state, and the control method for the UAV obstacle avoidance system comprises:
estimating whether the environment light brightness is below a preset threshold; and
when the environment light brightness is lower than the preset threshold, turning on the infrared light source, and switching, by the infrared shutter, the infrared cut-off filter to a turn-off state, so as to allow the infrared light enters the infrared filter region of the sensing unit.

16. The control method for a UAV obstacle avoidance system according to claim 15, further comprising:
when the environment light brightness is higher than the preset threshold, turning off the infrared light source, and switching, by the infrared shutter, the infrared cut-off filter to a turn-on state.

17. The control method for a UAV obstacle avoidance system according to claim 15, wherein the UAV obstacle avoidance system further comprises an environment detecting lens module, and the method of estimating whether the environment light brightness is lower than the preset threshold comprises:
capturing environment image information by the environment detecting lens module;
estimating the environment light brightness based on the environment image information; and
judging whether the environment light brightness is lower than the preset threshold.

18. The control method for a UAV obstacle avoidance system according to claim 15, further comprising:
capturing image information by the at least two obstacle avoidance lens modules; and
estimating whether an obstacle is in front based on the multiple pieces of image information, and further calculating the distance from the obstacle to the UAV obstacle avoidance system in the presence of the obstacle.

19. The control method for a UAV obstacle avoidance system according to claim 15, wherein the infrared filter region comprises a filter material allowing the infrared light to pass, and the light wave band penetrating the filter material ranges from 0.75 to 10 micrometers for allowing at least the infrared light to pass.

20. The control method for a UAV obstacle avoidance system according to claim 15, wherein the sensing unit further comprises at least one visible light filter region, the infrared filter region comprises a filter material allowing the infrared light to pass, and the light wave band penetrating the filter material ranges from 0.75 to 3 micrometers for allowing at least the infrared light to pass.
